(19) United States
(12) Patent Application Publication
(10) Pub. No.: US 2008/0016737 A1
(43) Pub. Date: Jan. 24, 2008

(54) HIGHWAY DIRECTIONAL SIGN APPARTUS, SYSTEM AND METHOD

(76) Inventor: CLIFFORD C. WILLIAMS, Las Cruces, NM (US)

Correspondence Address: MCKEE, VOORHEES & SEASE, P.L.C., 801 GRAND AVENUE, SUITE 3200, DES MOINES, IA, 50309-2721, US

(21) Appl. No.: 11/426,733

(22) Filed: Jun. 27, 2006

(51) Int. Cl. G09F 7/00

(52) U.S. Cl. 40/612

(57) ABSTRACT

An apparatus, method, and system for highway signs, particularly those related to highway or route number and direction information related to that highway or route number. The apparatus includes a highway or route number on the sign. A high visibility portion is physically positioned relative to the route number in a manner correlated to a cardinal point compass direction relative to the route number. By this relationship, a driver will immediately perceive directional information related to the route number by the position of the portion on the sign.

### BACKGROUND OF THE INVENTION

Since construction of what is now historic Route 66, road and highway signage has evolved in a seemingly random way, sometimes according to local custom, often by whim or bias of the designer. Presently, the traveler has been poorly served, too frequently creating confusion, delay, and loss of time, all contributing to unsafe, expensive travel.

### FIELD OF THE INVENTION

The present invention relates to a method, apparatus, and system for the presentation of information to a highway driver and, more particularly, to a way to present that information through visual cues, superior to those used in the past or present.

The conventional protocol and configurations for signs indicating highway numbers and routes tends to be standardized. As shown in FIGS. 1A, 2A, 3A, 4A, 5A, 6A, 7A, 8A, highway numbers tend to be larger and emphasized. Directions regarding the highway number (the driver's direction such as “east” or “west” relative to an east and west highway route) tend to be placed in a standardized position or, sometimes, in a random position relative to the number. For example, a driver on Interstate 25 North would be presented with standard route sign 10 of FIG. 1A. The highway number 12 is below the designation “North”. In comparison, a driver traveling the opposite direction on Interstate 25 would be presented the sign of FIG. 2A. The route number “25” is beneath the direction the driver is heading, namely “South”.

FIGS. 3A and 4A show placement of the direction (“North”, “South”, “East”, “West”) are above the route number for route signs.

For a driver to discern the route number and direction requires the driver to be able to read both the route number (which is somewhat larger and accentuated), but also the somewhat smaller direction. At modern highway speeds, particular freeways and interstates, this can be difficult. Because direction is always placed over route number, it is smaller. But perhaps more importantly, it is sometimes difficult to discern the difference between the four letter “East” and four letter “West” and/or five letter “North” and five letter “South”.

The direction is obviously considered important as it is a part of the present protocol of highway signage. However, it is submitted that the present protocol does present problems and that there is room for improvement regarding these route signs.

Difficulties in reading and interpreting highway signs is perhaps even more pronounced regarding signs intended to give information to drivers other than plain route marker signs. For example, FIGS. 5A and 6A show what will be called “To” signs, intended to tell the driver how to get to a certain highway of a certain direction. Note how the conventional protocol of the route marker is continued. The route number 12 is prominent with the direction less prominent but immediately above the route number regardless of which direction it indicates. In addition to the standard route marker components, drivers informed this is providing instructions as to how to get to that route. FIG. 5A literally has the word “To” (see Reference No. 22). It can also have additional instructions such as informing which lane the driver should migrate to (see Reference No. 24). FIG. 6A is an alternative. It still shows route number 12 prominently with route direction 16 less prominent but immediately above route number 12. In this case arrow 26 tries to inform the driver which direction to migrate to to get to that route.

Similar problems exist as previously described. In a busy environment, at highway speeds, and/or in a complex intersection or unfamiliar location, it requires the driver to read, interpret, and accurately process the information. This can be distracting.

Examples of more complex problems in the art are shown in FIGS. 7A and 8A. In what will be called “combination signs” 30 and 40, more than one route number is presented and the signs are intended to inform the driver which of a variety of choices he/she has and how to migrate to a choice. Note how FIG. 7A route numbers (Reference Nos. 12A and 12B) are presented for two choices. Only one direction (Reference No. 16A) is given relative to a route number and that direction “North” is to the left side of the route number “25”. No directions are given for route “70”. The intended meaning is that if the driver goes in that direction there will be a junction for full east and west Interstate 70, although that information is not explicit on the sign.

Note in FIG. 8A that the driver is instructed that the two directions of Interstate 70 go in different directions but that the actual direction (Reference Nos. 16A and 16B), namely “west” or “east” are both to the right side of the route number.

Again, at highway speeds, and right before the split off, the driver must first be able to discern and read the direction information, but then must be able to correctly and quickly process it to make the right selection.

As can be appreciated, in situations where a driver has trouble reading signs from a distance or for other reasons is given little time between being able to read the sign and make the decision, this can present significant safety issues for traffic. It can cause drivers to slow down, which can disrupt traffic or cause rear end accidents. It can cause drivers to panic and make a last second lane change decisions. Furthermore, errors in interpreting these signs can cause errors which direction the driver takes which can result in loss of time and wasted fuel. Signs may be difficult to read because of the placement of the sign, or the speed or distance from the sign. But also, difficulties can arise because of environmental conditions such as lack of light, dirt accumulation, fog, snow, sleet, rain, and the like, which fully or even partially obstructs clear view of the sign. This can not only present inconvenience for the driver, but a safety issue for the driver and other cars near that driver.

It is therefore been identified that there is a real need in the art for an improvement in the art of highway signage.

### BRIEF SUMMARY OF THE INVENTION

It is therefore a primary object, feature, advantage, or aspect of the present invention to improve upon the state of the art.

Other objects, features, advantages, and/or aspects of the present invention include an apparatus and method which:
a. Is ecomonical and efficient to produce and install.
b. Is efficient in the sense that it quickly and clearly conveys vital information including route identification and direction of travel to the motorist, based on visual signals, easily perceived and interpreted.
c. Is durable and requires minimal maintenance.
d. Is adaptable to a variety of different and numerous configurations.
e. Provides a better way for drivers to discern information regarding highway routes, junctions, interchanges, and other information related to direction and highways.
f. Promotes highway safety.
g. Promotes accuracy in driving.
h. Promotes efficient use of time and fuel in driving.
i. Promotes quicker recognition of directional information regarding highways.
j. Decreases the amount of reliance on ability to read and interpret information on highway signs.
k. Promotes a more consistent, accurate, and logical highway sign protocol.
l. Promotes a more universally recognizable highway direction protocol, including one that is universal to people of all backgrounds and languages.

According to one aspect of the invention a method for presenting directional information related to highway routes or numbers comprises presenting the highway route number to the driver in a visually perceivable way and presenting directional information relevant to that highway number and the driver at the location of the signage by standardized highly visually perceivable sign portion that is physically positioned relative to highway number in a manner corresponding to compass points. An example would be that the highly visible portion is above the number if the directional information relates to the direction “North”, is below the number if it relates to “South”, is to the right of the number if it relates to “East” and is to the left of the number if it relates to “West”. In this manner, the driver need only perceive the physical location of the highly perceivable portion relative to the number in the manner such position would be relative to cardinal points of a compass relative to the number in a vertical plane.

In another aspect of the invention, more than one highly visible portion in a specific physical position relative to the number can be placed on the sign. One example is where the route number indicates an approaching junction for both directions of a highway (e.g. north and south). Two highly visible direction panels, one above the number and one below the number would allow the driver to immediately perceive the sign relates to both directions, north and south, of that highway number.

In another aspect of the invention, an apparatus comprises a standardized sign base. A decal or separate piece having a background of the highly visible coloring or otherwise highly visible qualities of standardized size is configured to be placed on any of the four sides of the base sign. The remainder of the base sign is available for placement of highway route number and other information such as type of highway, arrows, exit numbers and the like. The universal nature of the sign would allow for economy in inventory of such signs.

These and other objects, features, aspects and/or advantages according to the present invention will become more apparent with reference to the accompanying specification and claims.

### BRIEF DESCRIPTION OF THE DRAWINGS

FIG. 1A is a front elevation view of what will be called a route sign according to prior art, indicating a highway number and a direction of travel for the driver coming towards the sign.

FIG. 1B is similar to FIG. 1A but shows an exemplary embodiment according to the invention.

FIGS. 2A and 2B are similar to FIGS. 1A and 1B, contrasting a variation of a route sign according to the prior art (FIG. 2A) and an embodiment according to present invention for that sign (FIG. 2B).

FIGS. 3A and 3B, 4A and 4B are similar to FIGS. 1A and 1B but for different variations of route signs.

FIG. 5A is a prior art front elevational depiction of what will be called a “to” sign. It indicates a highway number, the direction of travel relative to the highway number above the highway number, and an indication that if the driver wants to go to that route going that direction, he/she should follow the directions on the sign.

FIG. 5B is a version of the sign of FIG. 5A but according to an exemplary embodiment of the present invention.

FIGS. 6A and 6B are similar to FIGS. 5A and 5B but for a different version of a “to” highway sign.

FIG. 7A is what will be called a prior art “combination” sign. It combines two highway routes and gives information to the driver as to how to get to those routes. It also provides partial information that is directional in nature.

FIG. 7B is a version of the sign of FIG. 7A but according to an exemplary embodiment of the present invention.

FIGS. 8A and 8B are similar to FIGS. 7A and 7B but for a different version of a “combination sign”.

FIG. 9 is an elevation plan view of a universally adaptable steel blank with pre-drilled holes for mounting an any chosen orientation on standard steel posts in use throughout the country, according to an exemplary embodiment of the present invention. Background and directional panels on the blank are ready for attachment of decals showing route designation and direction.

FIGS. 10, 11, 12, and 13 are variations of the base sign of FIG. 9 with highway number information and directional information according to the present invention.

FIGS. 14 and 15 are similar to FIGS. 10-13 but illustrate universal base sign of FIG. 9 with multiple directional information according to the present invention.

FIG. 16 is similar to FIG. 12 but illustrates an alternative embodiment according to the present invention.

FIGS. 17A-D are front elevation plan views of alternative exemplary embodiments of route signs similar to those of FIGS. 1B, 2B, 3B, and 4B.

### DETAILED DESCRIPTION OF EXEMPLARY EMBODIMENTS OF THE INVENTION

### Overview

For a better understanding of the present invention, examples of how the invention can be implemented and practiced will now be set forth in detail. It is to be understood that variations to specific configurations can be made. These examples are for illustrative purposes only and do not define the scope of the invention, which is defined solely by its claims.

### Example 1

### “Route” Signs

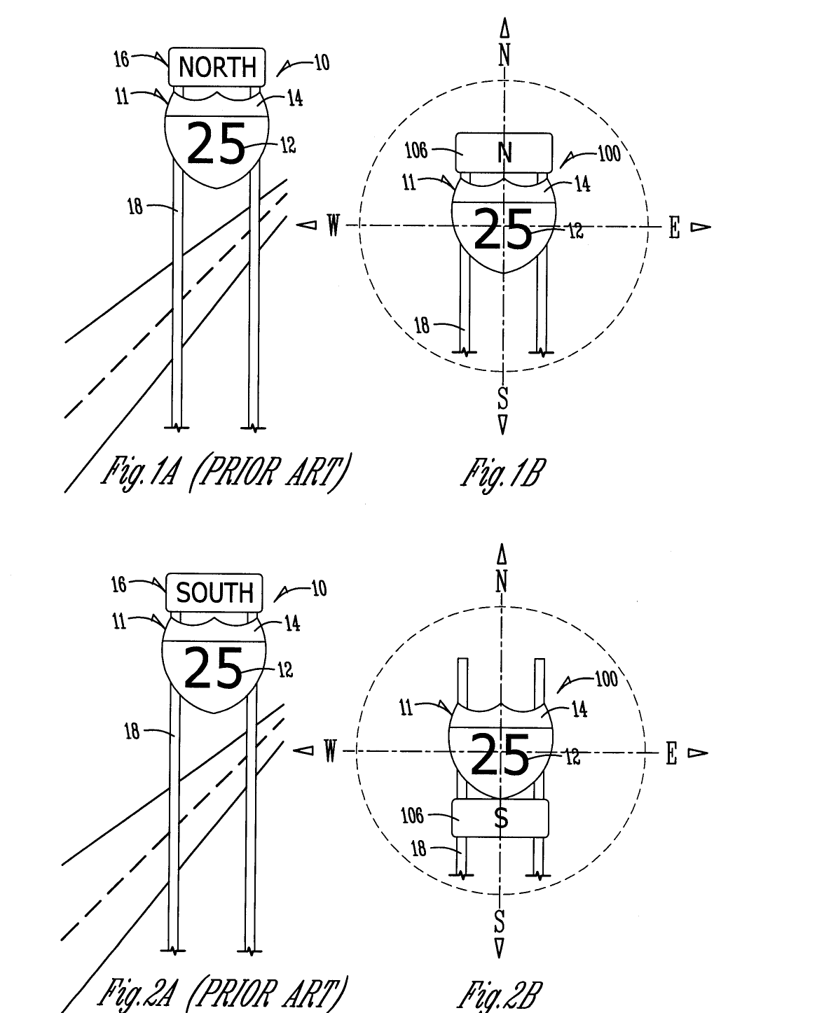

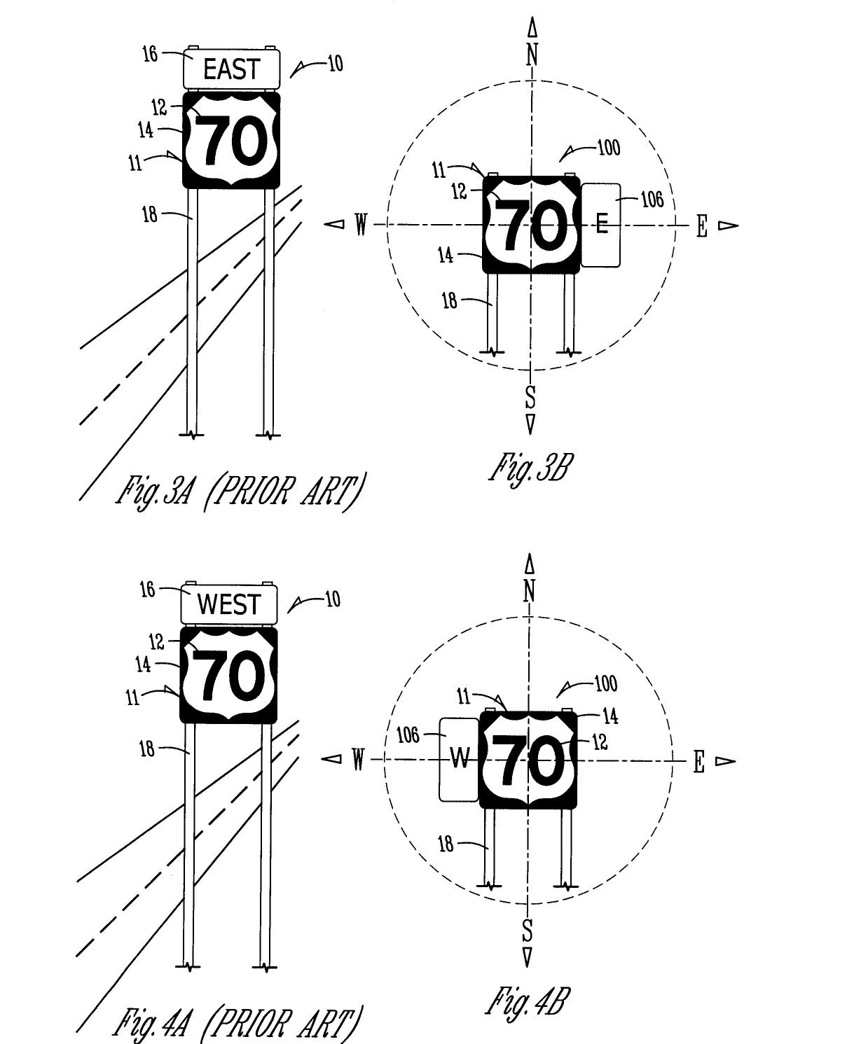

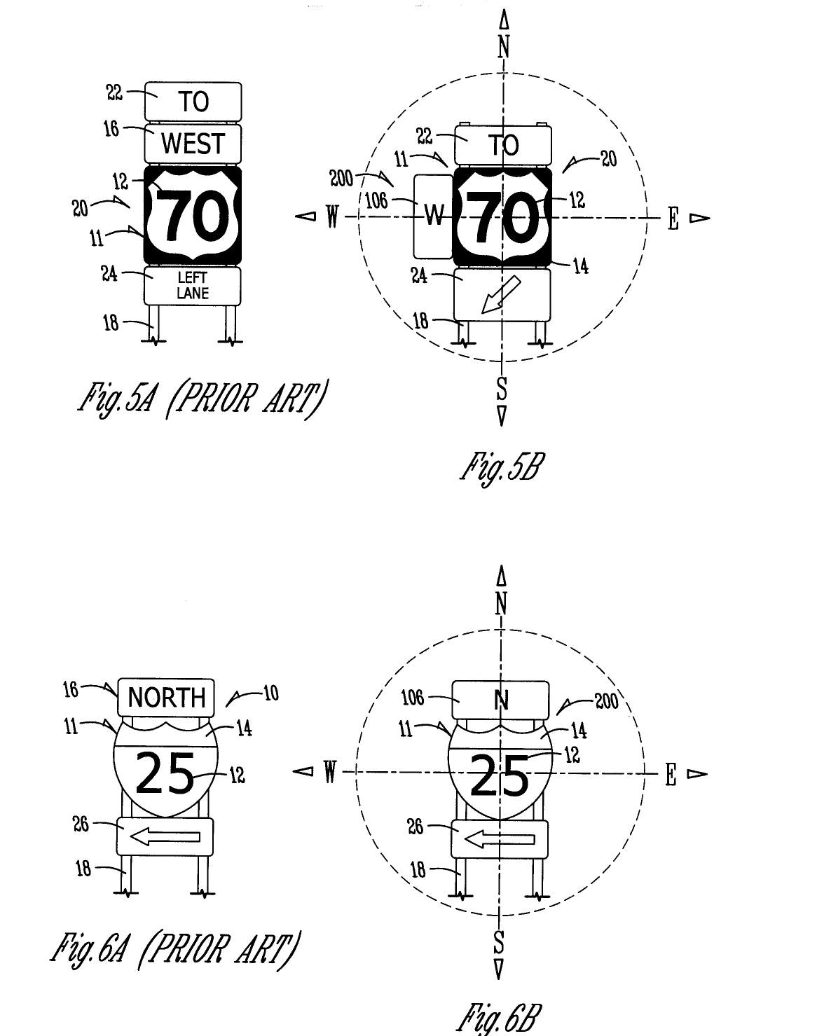

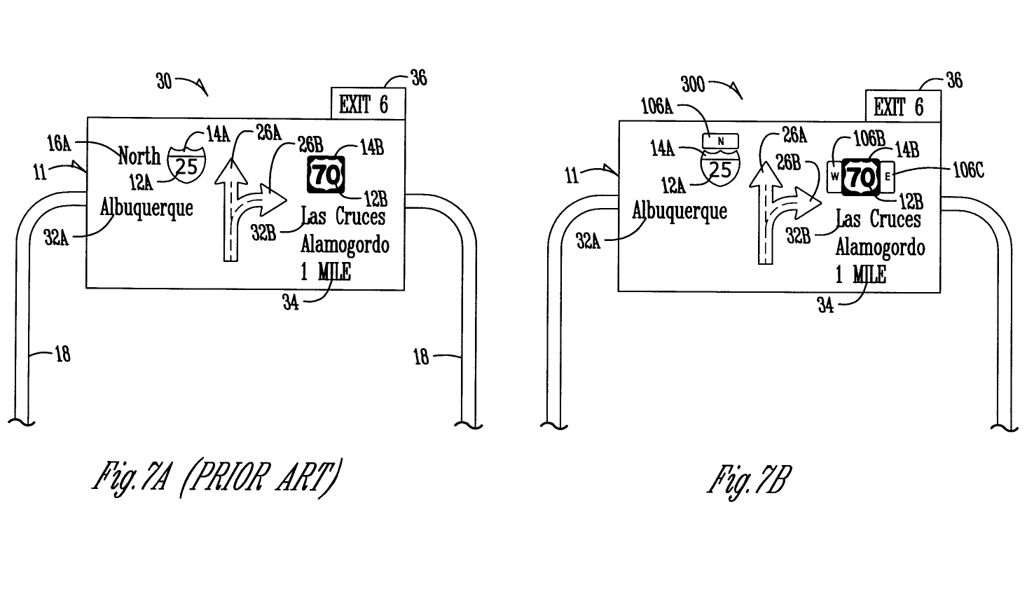

By route signs it is meant a sign that tells the driver the highway route number and the direction on that highway route number the driver is traveling. FIG. 1A is a depiction of a conventional state of the art route sign 10. A separate base sign 11 includes route number 12 (in this case it is route number “25”). It also has a shape and indicia 14 indicating the type of highway; here a U.S. interstate highway sign shape, conventional protocol color combination of red with the word “Interstate” at the top, and bottom being blue. Like conventional protocol, the highway number 12 is in white letters that are relatively large compared to the other information on the sign.).

Two support legs 18 elevate the sign for viewing. A separate sign 16 has a blue background, white border, and in white letters the direction “North”. It is placed immediately above the base sign 11 and supported by supports 18 also.

FIG. 2A shows the same route sign for interstate 25 south. The directional sign 16, in FIG. 2A indicating “south”, is again placed immediately above the base sign 11 with highway number “25”.

Similarly, for interstates going east and west, FIGS. 3A and 4A show the standard protocol of route number 12 on a base sign 11 with directional sign 16 above with smaller letters indicating direction (here “east” or “west”).

The protocol is standardized regardless of route number or direction. Whether “north”, “south”, “east”, or “west”, that word, in relatively small letters, is placed on top of or above the route number which is in relatively larger size. The driver must therefore be able to read and interpret the relatively smaller direction information to know direction related to that route number.

In comparison, FIGS. 1B, 2B, 3B, and 4B illustrate exemplary embodiments of according to the present invention. These Figures illustrate principles of the invention relative to the prior art protocol of FIGS. 1A, 2A, 3A, and 4A respectively. As can be seen, the exemplary embodiment route signs still retain the base sign 11 with the route number 12 prominently placed on the base sign shape and/or other information on the base sign letting the driver know what type of highway the route comprises. However, in the exemplary embodiment route sign (reference no. 100); the primary difference are a separate sign 106 corresponding to the route direction is placed in a physical position (a) generally in the plane of base sign 11 and (b) relative to the route number in a direction which corresponds with a functional compass point or points in that plane, where north is above the route number, south is below, east is right, and west is left. This is illustrated in FIGS. 1B, 2B, 3B, and 4B. In short, the location of portion 106 corresponds to a cardinal point compass direction relative to the route number of the highway. The driver can immediately discern, by the position of portion 106, the directional information related to the route number, even if no writing or directional textual information is on portion 106.

As indicated, however, in these drawings, in this embodiment directional information such as “N”, “S”, “W”, or “E” can be placed on portion 106 in lieu of the full word “NORTH”, “SOUTH”, “EAST”, or “WEST”, because, by location of portion 106 relative to the route number, the driver will know the intended indication of direction. Alternatively, of course, the full direction word “NORTH”, “SOUTH”, “EAST”, or “WEST” could be placed in portion 106. Still further, portion 106 could be devoid of any text. Its placement alone relative the route number would indicate direction.

The fundamental concept, however, is that the physical placement of portion 106 around the route number corresponds with the cardinal point direction intended to be conveyed. Portion 106 can be painted, a decal, a combination of the same, or some other indicia. Portion 106 can be of a characteristic designed for high visibility by drivers. An example would be a color different from most or all of the colors associated with the route information. Further, it could be a bright or high visibility color. One example is bright orange or bright reddish-orange. It could also be reflective or retro-reflective.

### Example 2

### “To” Signs

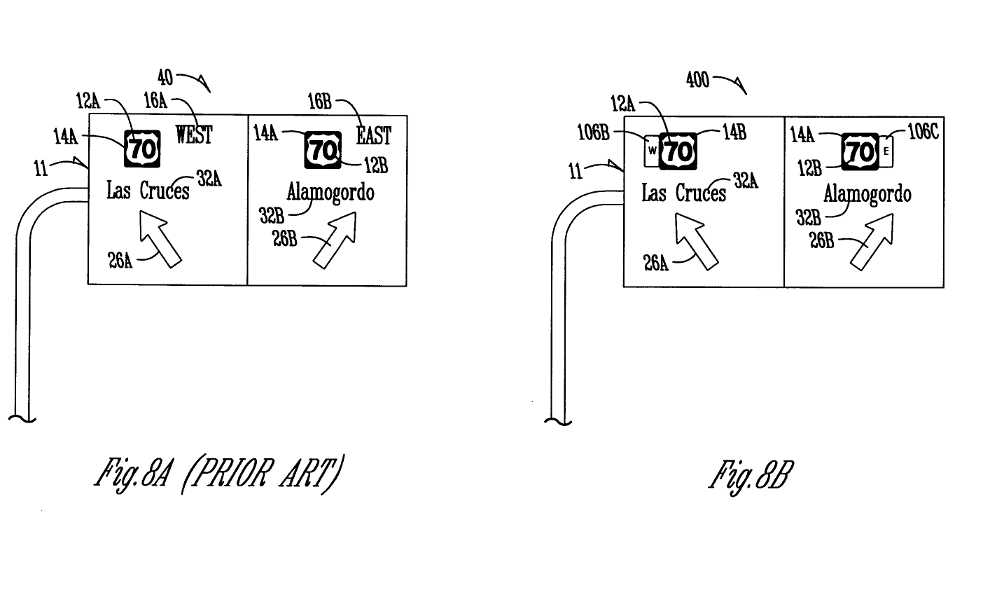

FIGS. 5B and 6B illustrate how the principal described regarding the route signs can similarly be applied to “To” signs. In FIG. 5B, the information to be conveyed to the driver is that the way to Route 70 West is in the left lane. FIG. 5A shows the present protocol requires the driver to read “west” above the route number. FIG. 5B that according to the embodiment of the present invention, highly visible portion 106 is placed to the left of the route number “70” to indicate this sign relates to Route 70 West. If it related to Route 70 East, portion 106 would be on the right side of route number 70. If there was a Route 70 North, portion 106 would be above the route number and if there was a Route 70 South, portion 106 would be placed underneath the route number.

FIG. 6B illustrates a similar principal. In this case, the sign is directing the driver to Route 25 North. In this case it so happens, as shown in FIG. 6A, that direction indication 16 on the conventional sign is above the route number. However, in the present invention, it is not required that the entire word “North” be placed on direction indication portion 106. Rather, in a preferred embodiment, portion 106 is simply placed at the corresponding cardinal point relative to the direction and relative to the physical position of the route number. It is further preferred that portion 106 be a highly visible color or have some other highly perceivable characteristic that from quite a distance the driver can see its existence and its position relative to the route number.

### Example 3

### “Combination Signs”

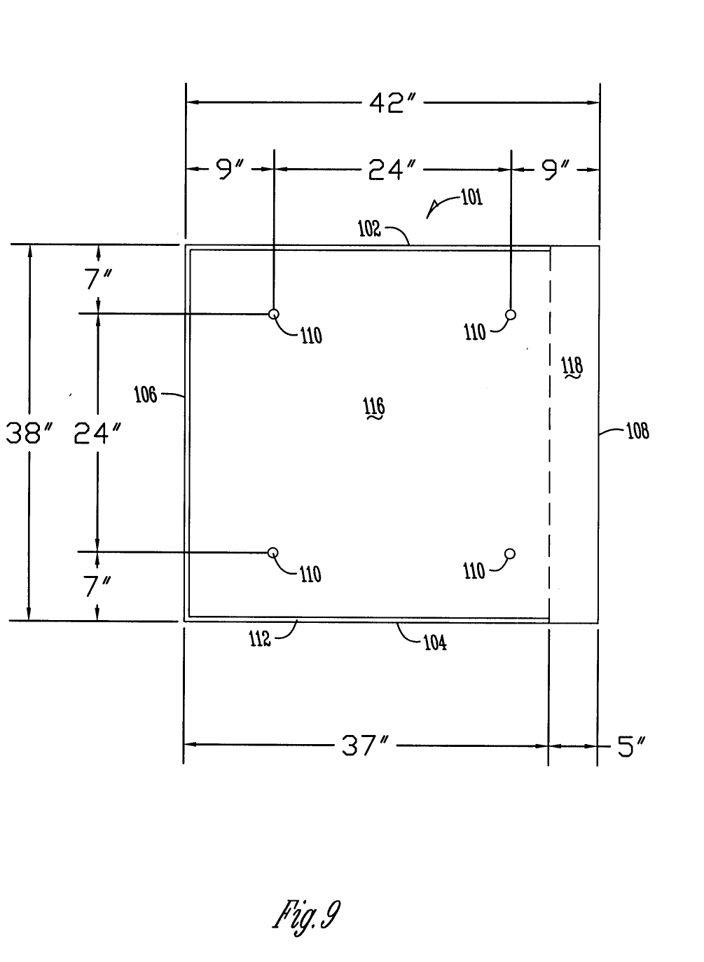

FIGS. 7B and 8B show examples of signs where a variety of directional and route information is presented. The same concept as Examples 1 and 2 applies. A highly visible portion 106 indicating direction relative to a route number is physically placed in a corresponding cardinal point compass position relative the route number to indicate direction, as opposed to uniformly above the route number with the actual word “NORTH”, “SOUTH”, “EAST” or “WEST”. Thus, in FIG. 7B, the driver would see portion 106A above interstate route number “25” and know the sign is indicating by the center arrow the direction of Interstate 25 North. In the same sign, portions 106B and C indicate to the driver, with the right-pointing smaller arrow, that access to both east and west directions of Interstate 70 is available by taking the next right turn.

Similarly, FIG. 8B shows the driver that Interstate 70 West is the left lane (by the left-pointing arrow and the position of portion 106A), and Interstate 70 East is the right lane (by the right-pointing arrow and the position of portion 106B).

In summary, below are several “rules” regarding this exemplary embodiment;
a. Placing the highly visible portion above the route number if attempting to convey the information “North” regarding the route number.
b. Placing the highly visible portion to the right side of the route number if conveying the idea “East”.
c. Placing the highly visible portion below the route number if conveying “South”.
d. Placing the highly visible portion to the left of the route number if conveying “West”.
e. Placing highly visible portions on opposite sides of the route number if trying to convey information about both compass directions relative to a route number (e.g. if directing a driver to a route number, not just a single direction relative to the route number).
f. Placing more than one highly visible portion relative to a single side if compass information regarding more than two compass directions is desired for that sign.

With respect to the sub-parts A and B of FIGS. 1-8, these concepts can be seen.

### Universal-Type Sign

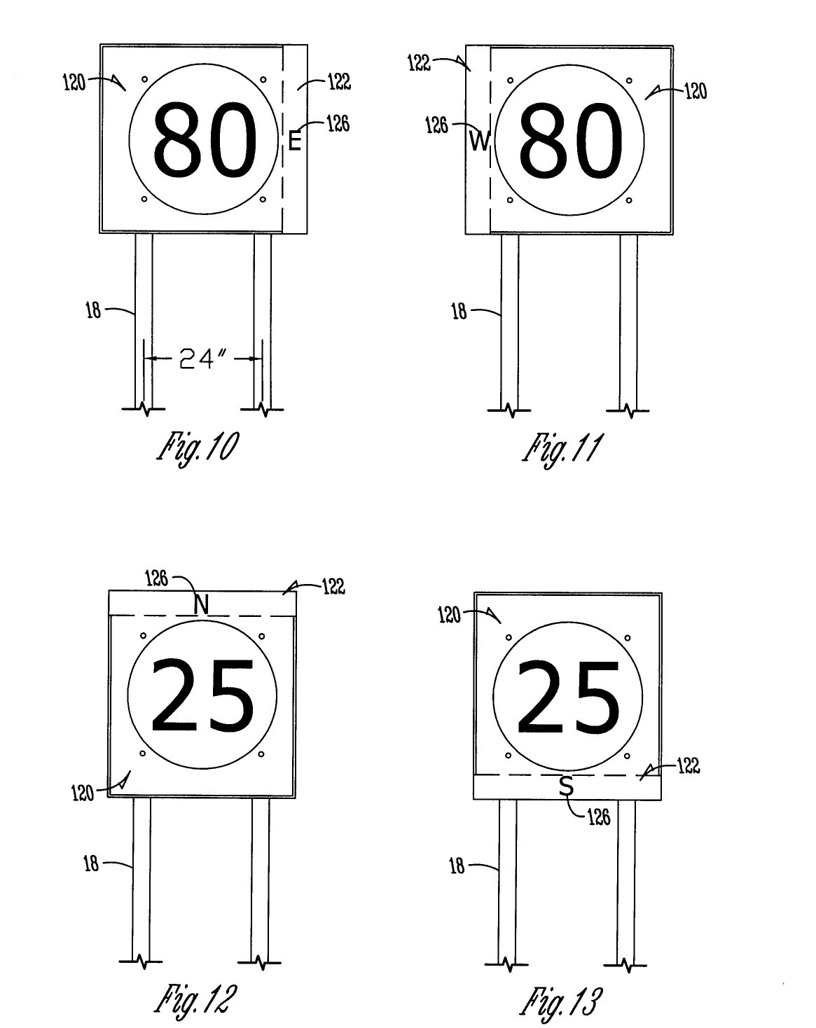

FIGS. 9-15 illustrate an exemplary embodiment of a mass-producible, universally adaptable steel blank 100 that could be used for any of the above mentioned configurations according to the present invention. In other words, an inventory of these signs could be maintained such that, economically and efficiently, different variations according to the present invention could be created from an efficient stock of inventory.

FIG. 9 shows in front elevation view, an exemplary embodiment of a universal sign 100 comprising a base rectangular member 101 (e.g. of galvanized sheet metal or aluminum sheet metal) of the basic dimensions (38 by 42 inches) shown in FIG. 9. Base number 101 would have a top 102, bottom 104, left side 107, and right side 108. Four mounting holes 110 would be adapted to mount by bolts or screws to vertical uprights such as have previously been discussed. Note that mounting holes 110 are at the corners of a 24 inch per side square. This allows mounting to posts spaced on center 24 inches apart at four different rotational orientations.

Optionally, base member 101 could have a border 112 (for example a one half inch black border of some appropriate color such as white which is used on many present highway signs of this type). In the embodiment of FIG. 9, border 112 extends around just three sides (namely sides 102, 107, and 104). This allows what is applied to direction space 118 to stand out more. The background of base or blank 101 could be a gloss white or some other chosen color. It could be a neutral color such as light blue.

As illustrated in FIG. 9, and then further illustrated in FIGS. 11-15, the size of sign base 101 is selected such that a substantial majority would be used as what will be called “sign detail space 116”, about 38 by 38 inches (e.g. for highway numbers, information, and other graphic or textual information related to the route number such as shown in the earlier drawings, except for compass direction). The route number and/or other information could be painted over space 116 or a decal applied over space 116 (except for its border 112). A smaller space on the sign, 5 by 38 inches (designated by Reference No. 118 as an example in FIG. 9), would be reserved for what will be called “direction space 118” (e.g. for painting or a decal like highly visible portion 106) to specific a cardinal point compass direction relative to the sign detail space 116.

In FIG. 9, steel blank 101 is turned so that direction space 118 is shown to the right of sign detail space 116, meaning it would be indicating the direction “East”. As indicated in FIGS. 9 and 10, this space 118 in this embodiment is approximately 5 inches wide but the entire height of base sign 101. Decals or paint with the route information and a highly visible portion 106 are applied to spaces 116 and 118 respectively.

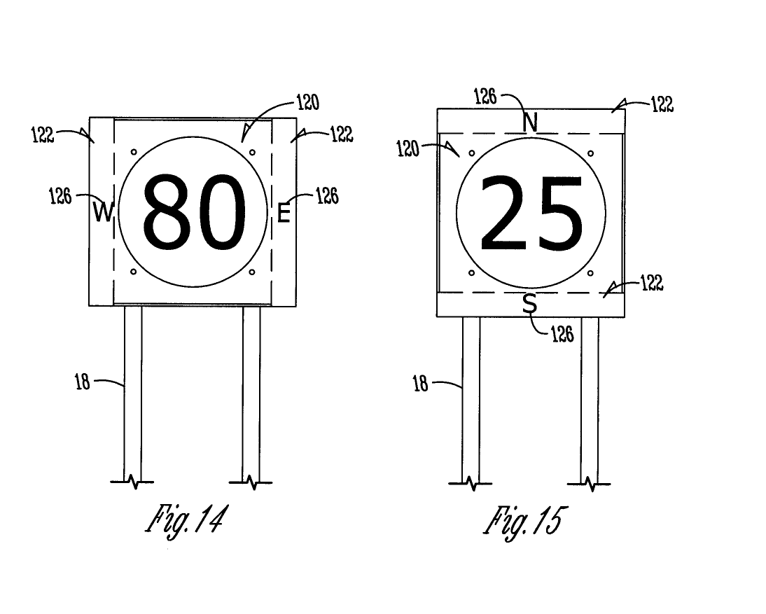

To use universal sign blank 101 to indicate “north”, steel blank 101 would be rotated ninety degrees counter-clockwise from that shown in FIG. 10 so that direction space 118 is on top (FIG. 12). To indicate “west”, a further ninety degrees counterclockwise rotation is made (FIG. 11); and for “south”, a further ninety degrees counterclockwise (FIG. 13). Thus, steel blank 100 can simply be mounted in any of those four positions to indicate any of those four directions. The direction space 118 can be adjusted to any of the four cardinal compass points relative the detail space 116. And the detail space 116 and direction space 118 each have the same size, no matter which position steel blank 100 is turned. Therefore, an inventory of universal sign blanks 101 can be mass produced and kept ready for use. And an inventory of route number and/or other information decals and highly visible direction portions 106, each of standard size to fit, respectively, into spaces 116 and 118 of sign blanks 101, can be created and kept in stock.

FIGS. 10-13 illustrate four different single direction permutations for the universal sign 100, namely in order indicating east, west, north, and south respectively. As shown, the direction space could also include, over and above just highly visible color or other ornamentation, some specific textural information. Here it is shown as just the single letter compass points E, W, N, or S. Different full spelling of each of those directions could be used, of course.

In this embodiment, a plurality of universal sign bases or blanks 101 would be kept in inventory. Then, decals, for example, could be made of appropriate graphic and textual information of the correct size and orientation, and kept in inventory such that a variety of signs could be made from the same base sign 101. As is indicated in FIGS. 9-15, an inventory of decals 120 for route number 25 could be created and kept in inventory. Inventories of multiple “N”, “E”, “S”, and “W,” 5 inch by 38 inch decals could be kept in inventory. When a route sign needing to indicate Interstate 25 North is needed, sign base or blank 101 would be turned to the orientation of FIG. 12, a decal 120 with route number 25 (and any additional information that might be needed) would be placed in the lower portion (38 by 38 inch space 116) of sign base 101. A highly visible 5 inches tall by 38 inches wide “N” portion 122 would be taken out of inventory and applied by adhesives or other means above the route number decal 120 in space 118 (5 by 38 inch). The sign would be completed. See FIG. 12.

Similarly, blank 101 could be rotated 180 degrees and the same Route 25 decal 120 could be placed at the upper portion of sign base 101 and a “S”, 5 inch tall by 38 inch wide highly visible decal 122 could be placed at the bottom of sign base 101 to complete a Route 25 South sign.

FIGS. 10 and 11 illustrate that for east/west routes, a similar assembly process would be used. An inventory of Route 80 decals could be kept that would occupy most of space 118 of base sign 101 (rotated so its 42 inch dimension between opposite vertical sides and its 38 inch dimension is between top and bottom sides). Inventories of 38 inch tall by 5 inch wide east or west highly visible decals 122 could be kept. Positioning of decals as indicated in FIGS. 10 and 11 would allow the same sign base 101 to create either Route 80 East or Route 80 West signs.

FIGS. 14 and 15 show that universal signs 100 could also be easily configured from the same inventory, using the same sign base 101, for signs needing to indicate two opposite directions relative to the route number. The route decals 120 would have to be a bit smaller in overall dimensions to allow decals 122A and 122B (the opposite highly visible compass point direction decals) to be put on the same base sign 101. Alternatively, they could overlap over a portion of the route decal 120. Even so, the inventory of decals could be in place to allow the same universal sign 101 base to be used.

### Options and Alternatives

It will be appreciated that the present invention can take many forms and embodiments. The foregoing exemplary embodiments are intended to only show a few examples to help in an understanding of the invention. These examples are not by way of limitation.

For example, the precise configuration of the highly visible compass direction panel can take different forms and embodiments. In the exemplary embodiments, it is believed preferable that highly visible portion indicating a cardinal point compass direction(s) be at least substantially uniform in color or other highly visually perceptible characteristics so that drivers will become accustomed to looking for that characteristic. Furthermore, it is preferable that characteristic be perceivable from as long a distance as possible over a variety of driving conditions. However, it does not necessarily have to be rectangular in shape. It also does not necessarily have to be limited in color. For example, it might be that different highly visible colors are associated with each of the four cardinal compass points.

Furthermore, a variety of other techniques such as reflectivity, could be used to increase the distinctiveness or visual perception ability of these portions for the driver. One example would be reflectivity (or retro-reflectivity). Another would be the use of lights (e.g. LED or LEDs, solar powered).

While a universal sign, as shown in FIG. 9, is believed to be beneficial, as indicated with the other embodiments, the signs themselves can take a variety of different shapes and configurations. For example, in FIG. 7B, the highly visible portions indicating cardinal compass point directions can be placed inside the perimeter dimensions of the sign indicating highway number or other information.

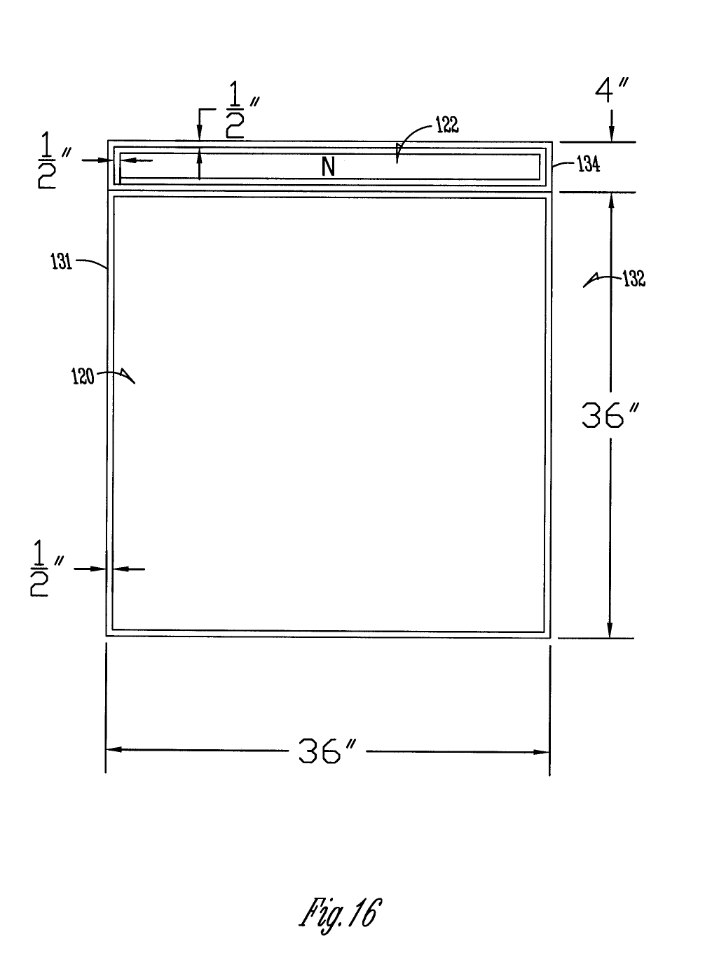

On the other hand, FIG. 16 illustrates that with an alternative embodiment sign 132, highway route and other information 120 could occupy most of the space on sign 132. A separate sign or piece 134 could be a attached, mounted, or suspended adjacent to any side of base sign 132. Note additionally that directional portion 122 could itself have some sort of border. In this case, the background of directional portion 122 has a bright reddish orange high visibility background and the border is a half inch black border.

FIGS. 17A-D show examples of non-symmetrical signs that utilize principles of the invention. As can be seen, highly visible portions 106 are positioned at cardinal point compass directions relative the route number to communicate to drivers a direction associated with the route number.

It should also be understood that more than just the four cardinal point compass directions could be indicated with the invention. For example, intermediate compass points such as northwest, southwest, southeast, northeast could similarly be identified through placement of a highly visible portion in a corresponding compass point direction from a route number.

The universal sign, or any embodiment, can be scaled up or down, according to need.

Variations obvious to those skilled in the art will be included within the invention.

What is claimed is:

1. A highway sign having a surface comprising:
a. a highway or route number portion on the surface; and
b. a direction portion, distinguishable from the highway or route number portion, placed relative to the highway or route number corresponding to a compass point direction.

2. The highway sign of claim 1 when the surface comprises a top, bottom, left side, and right side, the top, bottom, left side and right side corresponding respectively to north, south, west, and east, compass points.

3. The highway sign of claim 1 wherein the direction portion is on the surface of the sign.

4. The highway sign of claim 1 wherein the direction portion is adjacent to the surface of the highway sign.

5. The highway sign of claim 1 wherein the highway or route number portion includes additional information to instruct a driver.

6. The highway sign of claim 1 wherein the direction portion comprises a high visibility characteristic.

7. The highway sign of claim 6 wherein the high visibility characteristic comprises color.

8. The highway sign of claim 6 wherein the high visibility characteristic comprises reflectivity.

9. The highway sign of claim 1 wherein the direction portion comprises a predetermined size, shape and/or color.

10. A method for presenting information to drivers on or regarding highways comprising:
a. presenting a highway or route number on a sign;
b. placing an indicia, distinguishable from the highway or route number in a position around the highway or route number corresponding to a cardinal compass point;
so that by position of the portion the driver understands directional information relative to the route number.

11. The method of claim 10 wherein the portion has a high visibility characteristic selected from color, reflectivity, size and/or shape.

12. The method of claim 10 wherein the correlation of position of the portion relative to the route number is consistent for different signs.

13. The method of claim 10 further comprising second portion position relative to the highway or route number to indicate additional different direction information.

14. The method of claim 10 wherein the direction portion includes additional indicia.

15. A highway sign comprising:
a. a base of perimeter dimensions and having a surface;
b. a route or highway number section within perimeter of the base;
c. the remainder of the base comprising at least one direction portion.

16. The highway sign of claim 15 wherein the route or highway number portion is adapted to receive highway or route information and the direction portion is adapted to receive direction information.

17. The highway sign of claim 16 wherein the highway or route number information comprises a decal.

18. The highway sign of claim 16 wherein the direction information comprises a decal.

19. The highway sign of claim 16 wherein the highway or route number of direction information comprises one of paint, an overlay, or picture.

20. The highway sign of claim 15 wherein the remainder comprises two direction portions.

21. A method for creating a plurality of highway signs related to highway or route numbers and directional numbers regarding highway or route numbers comprising:
a. an inventory of essentially same size base signs;
b. an inventory of route number decals, paint templates, plaques, or overlays;
c. an inventory of high visibility decals, paint templates, plaques, or overlays;
d. sizing and positioning a highway or route number decal, template, plaque or overlay on part of the base sign;
e. positioning a direction decal, template, plaque or overlay on a different portion of the base sign, but in a position correlated to cardinal compass point related to position of the route number in the plane of the base sign.
